(19) United States
(12) Patent Application Publication
(10) Pub. No.: US 2026/0159433 A1
(43) Pub. Date: Jun. 11, 2026

(54) DEVICES AND METHODS FOR CONVEYING MOLTEN GLASS

(71) Applicant: CAIHONG DISPLAY DEVICES CO., LTD., Xianyang (CN)

(72) Inventors: Menglong WANG, Xianyang (CN); Hongrong HOU, Xianyang (CN); Wei YANG, Xianyang (CN); Chao YU, Xianyang (CN); Ting LUO, Xianyang (CN)

(73) Assignee: CAIHONG DISPLAY DEVICES CO., LTD., Xianyang (CN)

(21) Appl. No.: 19/387,536

(22) Filed: Nov. 12, 2025

Related U.S. Application Data
(63) Continuation-in-part of application No. PCT/CN2025/112013, filed on Jul. 31, 2025.

(30) Foreign Application Priority Data
Dec. 5, 2024 (CN) 202411781213.2

(51) Int. Cl. C03B 7/094; C03B 7/00; C03B 7/084

(52) U.S. Cl. CPC C03B 7/094; C03B 7/005; C03B 7/084

(57) ABSTRACT

A device and a method for conveying molten glass are provided. The device for conveying molten glass includes: a conduit structure, and at least one of a first cooling system or a second cooling system. The conduit structure axially penetrates through a throat in a throat brick to form a transmission channel for a glass fluid, the conduit structure including at least one metal conduit; the first cooling system is disposed on an inner wall of the throat and is not in direct contact with the conduit structure; and the second cooling system is arranged inside the throat brick.

### CROSS REFERENCE TO RELATED APPLICATION

This application is a Continuation-in-part of International Application No. PCT/CN2025/112013, filed on Jul. 31, 2025, which claims priority to Chinese Patent Application No. 202411781213.2, filed on Dec. 5, 2024, the entire contents of each of which are hereby incorporated by reference.

### TECHNICAL FIELD

The present disclosure generally relates to a field of flat glass manufacturing technology, and in particular to a device and a method for conveying molten glass.

### BACKGROUND

In a manufacturing process of substrate glass, a platinum channel plays a key role and is responsible for a fine processing and regulation of a glass fluid flowing out from a furnace to ensure an excellent quality and performance of the substrate glass. Main functions of the platinum channel include clarification, homogenization, temperature regulation, and flow control of the glass fluid. Clarification removes bubbles and impurities to improve the purity of the glass. Homogenization ensures compositional uniformity for stable physical and chemical properties. Precise temperature regulation maintains suitable viscosity and fluidity, which is beneficial for subsequent molding. Flow control accurately manages the output to satisfy production requirements.

A conduit connected between the furnace and the platinum channel is an important component to smoothly guide the glass fluid from the furnace into the platinum channel and to provide a transition and buffering effect. In early connections between the furnace and the platinum channel, relatively simple manners were used. For example, a channel built directly from refractory materials was used to connect a furnace outlet, or some ordinary metal conduits were used for connection. However, these early connection manners have many problems. Ordinary refractory materials or metal conduits are prone to severe corrosion and damage in a long-term high-temperature and glass fluid erosion environment, which not only leads to a short service life of the connection components, requiring frequent replacement and increasing production costs, but also affects the quality of the glass fluid and the stability of production.

With the development of glass manufacturing technology, the requirements for connection components have become increasingly higher. The platinum conduit is widely adopted mainly because it has a series of excellent properties. Platinum has extremely high chemical stability and high-temperature resistance, which remains relatively stable under prolonged high temperatures and glass fluid erosion. Using the platinum conduit effectively reduces the corrosion degree of the conduit, extends the service life of the conduit, and reduces the frequency of device maintenance and replacement. This helps to improve continuity and stability of production and reduce production interruptions and quality fluctuations caused by conduit problems. Furthermore, the platinum conduit provides a better glass fluid transmission performance. A surface of the platinum conduit is relatively smooth, which reduces a resistance to glass fluid flow, thereby maintaining the uniformity and stability of glass fluid compositions.

Furthermore, to further improve the service life of a throat brick, various cooling schemes are currently commonly used. For example, an air cooling scheme adopts a cooling air input system and a metal cooling box body to generate uniform airflow through exhaust holes across the surrounding pool wall. A scheme combining water cooling and air cooling is to dispose a water cooling coil on an outer surface of a throat covering brick, and set a forced air cooling pipe around the throat covering brick, which effectively reduces a temperature of a contact surface and prolongs the service life of the throat and even the entire furnace.

Specifically, based on an erosion mechanism of the throat brick by the glass fluid, the industry commonly uses cooling for suppression. The principles mainly include:
(1) Reducing temperature to slow down chemical reactions. The glass fluid aggressively erodes the throat brick at high temperatures, involving a series of complex chemical reactions. Physical cooling lowers a surface temperature of the throat brick. The decrease in temperature slows down the chemical reaction rate, thereby reducing the degree of chemical reaction between the glass fluid and the throat brick.
(2) Reducing thermal stress. The throat brick bears great thermal stress at high temperatures. When the temperature changes significantly, the thermal stress may cause damage such as cracks and spalling in a brick body. Physical cooling reduces the temperature gradient of the throat brick, thereby reducing the generation of the thermal stress. Furthermore, the cooling system makes the surface temperature of the throat brick more uniform, avoids local overheating or overcooling that causes stress-related damage, thereby extending the service life of the throat brick.
(3) Changing physical properties of the glass fluid. Cooling increases a viscosity of the glass fluid and reduces the fluidity, which weakens a scouring effect of the glass fluid on the throat brick, reduces the degree of physical erosion. The glass fluid with a higher viscosity has less friction on the brick body during flow, thereby reducing wear on a brick surface.

Traditional cooling schemes are generally arranged on an external surface of the throat brick, including manners such as tightly attached water pipes, spraying, and air pipe blowing. However, the improvement effect is generally limited due to the brick's substantial thickness, and the cooling effect only reaches a certain depth, which is unable to effectively suppress deeply internal regions.

Therefore, there is an urgent need for a device and a method for conveying molten glass from a furnace to improve the cooling effect on the throat brick, thereby reducing the temperature of the throat brick, reducing erosion, and enhancing the quality and efficiency of glass production.

### SUMMARY

One or more embodiments of the present disclosure provide a device for conveying molten glass, including: a conduit structure, and at least one of a first cooling system or a second cooling system. The conduit structure axially penetrates through a throat in a throat brick to form a transmission channel for a glass fluid, the conduit structure including at least one metal conduit. The first cooling system is disposed on an inner wall of the throat and is not in direct contact with the conduit structure; and the second cooling system is arranged inside the throat brick.

One or more embodiments of the present disclosure provide a method for conveying molten glass, implemented using the device for conveying molten glass described above. The method includes: disposing the first cooling system on the inner wall of the throat without contacting the conduit structure, and/or disposing the second cooling system inside the throat brick; axially penetrating the conduit structure through the throat in the throat brick to form the transmission channel for the glass fluid, the transmission channel configured to convey the glass fluid; and introducing a cooling medium into at least one of the first cooling system or the second cooling system to form a cooling flow path.

### BRIEF DESCRIPTION OF THE DRAWINGS

The present disclosure will be further illustrated by way of exemplary embodiments, which will be described in detail through the accompanying drawings. These embodiments are not limiting, and in these embodiments, the same numbers denote the same structures, wherein:

FIG. 1 is a schematic diagram illustrating a structure of a first cooling system of a device for conveying molten glass according to some embodiments of the present disclosure;

FIG. 2 is a schematic diagram illustrating a structure of a second cooling system of a device for conveying molten glass according to some embodiments of the present disclosure;

FIG. 3 is a schematic diagram illustrating assembly sizes of a device for conveying molten glass according to some embodiments of the present disclosure;

FIG. 4 is a schematic diagram illustrating a bellows structure of a conduit of a device for conveying molten glass according to some embodiments of the present disclosure;

FIG. 5 is a schematic diagram illustrating a bellows form of a conduit of a device for conveying molten glass according to some embodiments of the present disclosure;

FIG. 6 is a schematic diagram illustrating an erosion state of a conduit and a throat brick without a protective structure in the prior art; and

FIG. 7 is a schematic diagram illustrating an erosion state of a throat brick after adding an internal protective plate structure to a device for conveying molten glass according to some embodiments of the present disclosure.

### REFERENCE NUMERALS

1, metal conduit; 2, throat brick; 3, external connection surface; 4, protective baffle; 5, first coolant inlet; 6, first coolant outlet; 7, glass fluid; 8, second coolant inlet; 9, second coolant outlet; 10, first bellows structure; 11, second bellows structure.

### DETAILED DESCRIPTION

As cited in the background technology, in the prior art, the throat brick is eroded by the glass fluid due to a poor cooling effect of the throat brick.

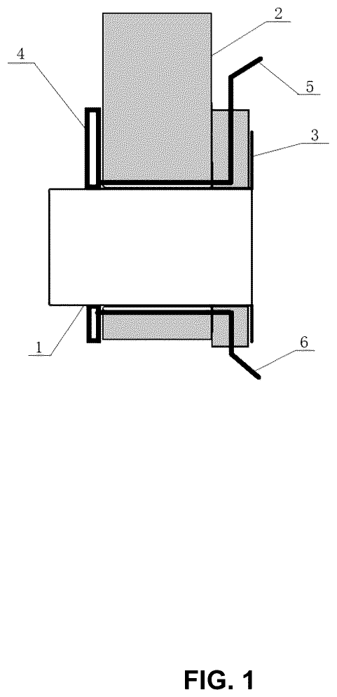

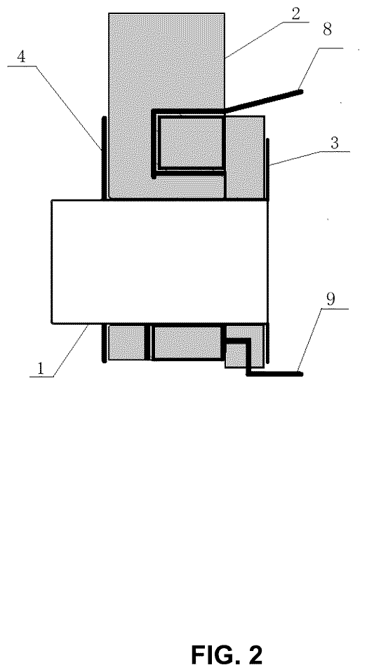

FIG. 1 is a schematic diagram illustrating a structure of a first cooling system of a device for conveying molten glass according to some embodiments of the present disclosure. FIG. 2 is a schematic diagram illustrating a structure of a second cooling system of a device for conveying molten glass according to some embodiments of the present disclosure.

In some embodiments, as shown in FIG. 1 and FIG. 2, the device for conveying molten glass includes a conduit structure, and at least one of the first cooling system or the second cooling system. The conduit structure axially penetrates through a throat in a throat brick 2 to form a transmission channel for a glass fluid 7. The conduit structure includes at least one metal conduit. The first cooling system is disposed on an inner wall of the throat and is not in direct contact with the conduit structure. The second cooling system is disposed inside the throat brick 2.

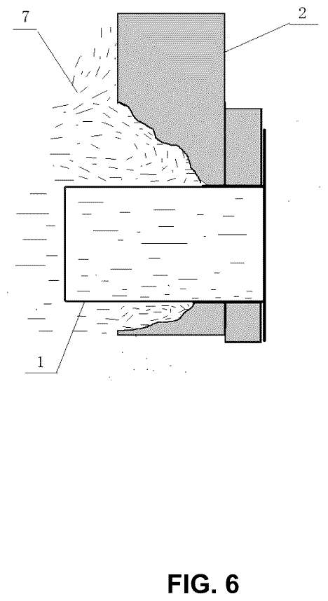

As shown in FIG. 6, for an early throat brick 2, the structure is extremely prone to damage due to direct erosion by the glass fluid 7. Furthermore, the erosion may alter a thermal conductivity of the throat brick 2. The thermal conductivity of refractory materials typically changes with an erosion degree, which may lead to a non-uniform temperature distribution inside the furnace, and affects a melting and forming process of the glass. Due to the shortened service life, the throat brick 2 needs to be replaced frequently, which not only increases a production cost but also affects a production efficiency of the furnace. Each replacement of the throat brick 2 requires a shutdown, leading to a production interruption and economic losses for the enterprise.

Therefore, in some embodiments of the present disclosure, a noble metal material with better high-temperature resistance and higher purity is selected as an inner lining cavity of the throat. This solves the erosion problem of the refractory material channel by the glass fluid 7. The noble metal material may include gold, silver, platinum, palladium, etc.

In some embodiments, the device for conveying molten glass is also referred to as a device for conveying molten glass from the furnace to a backend. The device is applied to a conveying stage of high-temperature molten glass in the glass manufacturing process. For example, on production lines for float glass, optical glass, or special glass, the molten glass needs to flow from a melting furnace to a forming groove or a flow channel system.

The conduit structure refers to a device for conveying a molten glass liquid. In some embodiments, the conduit structure includes at least one metal conduit. In some embodiments, the conduit structure is also referred to as a conduit structure for the molten glass.

The metal conduit refers to a hollow tubular component made of a metal material for transmitting a fluid.

In some embodiments, the at least one metal conduit is at least one conduit composed of platinum or a platinum alloy.

In some embodiments, the at least one metal conduit includes a noble metal material such as platinum, palladium, rhodium, iridium, rhenium, tantalum, etc. Furthermore, the noble metal material needs to satisfy following purity requirements: in terms of mass percentage, impurities in the noble metal material are less than 0.05%, where Fe element is less than 0.005%, and C element is less than 0.005%.

In some embodiments, the material of the at least one metal conduit is platinum, i.e., a mass percentage of platinum in the platinum material is 100%.

In some embodiments, the material of the at least one metal conduit is a combination of platinum and rhodium. The mass percentage of platinum is greater than 80%.

In some embodiments, a cross-sectional shape of the at least one metal conduit is circular.

In some embodiments, according to a temperature difference requirement between upper and lower limits of the at least one metal conduit, the cross-sectional shape of the at least one metal conduit is circular, elliptical, raceway-shaped, or other shapes containing a curved surface.

The first cooling system refers to a cooling device installed on an inner wall of the throat configured to cool without directly contacting an internal platinum conduit.

The second cooling system refers to a cooling device installed in the throat brick configured to indirectly provide protection for the internal glass liquid and conduit or create a temperature environment.

The throat brick refers to a refractory brick component in a glass furnace provided with a channel for the glass fluid to pass through. For example, the throat brick is a connecting component between the furnace and a backend channel, and a throat is formed in the throat brick.

The throat refers to a channel on the throat brick for guiding the molten glass liquid from the furnace to a subsequent working pool or forming device. For example, the throat is a hole penetrating through the throat brick, and the conduit structure is disposed therein.

The glass fluid refers to a glass material that is melted into a liquid state and possesses fluidity. For example, the glass fluid is high-temperature liquid glass flowing out from the furnace and flowing through the conduit structure and the transmission channel.

In some embodiments, the device for conveying molten glass includes at least one of the first cooling system and the second cooling system. In some embodiments, when the first cooling system is provided, a metal conduit 1 and the throat brick 2 are assembled in a cold state manner. Therefore, according to assembly and cooling requirements, an assembly gap t in millimeters is reserved between the metal conduit 1 and the throat brick 2. The assembly gap t and an outer diameter D of the metal conduit 1 satisfy the following relationship: 0.01 D<t<0.05 D, to satisfy installation requirements and the expansion requirements of the metal conduit 1 during the heating process.

The cold state manner refers to an assembly process in which a specific gap is reserved for mating parts at room temperature to accommodate their thermal expansion at a working temperature. The outer diameter D of the metal conduit may be determined according to actual requirements. For example, the outer diameter D of the metal conduit may satisfy: 40 mm<D<200 mm. In some embodiments of the present disclosure, the conduit structure penetrates through the throat in the throat brick to form the transmission channel for the glass fluid to transmit the glass fluid. The first cooling system is disposed on the inner wall of the throat and is not in direct contact with the conduit structure. The first cooling system is able to directly reduce the temperature of the glass fluid transmitted to the throat brick, effectively lower the temperature of the throat brick, slow down an erosion rate of the throat brick by the glass fluid, and extend a structural lifespan. The second cooling system is disposed inside the throat brick to make the throat brick better adapt to temperatures and erosion conditions of different portions through a segmented design, thereby enabling a flexible modular design and improving targeting and effectiveness of cooling. The second cooling system is able to directly cool the portions in contact with the glass fluid, further improving the cooling effect, reducing the temperature of the throat brick, reducing erosion, and enhancing the quality and efficiency of glass production.

In some embodiments, the throat brick further includes a dual-core temperature measurement grid and a central control unit. The central control unit is configured to control a cooling medium flow rate of at least one of the first cooling system or the second cooling system.

The dual-core temperature measurement grid refers to a distributed sensor network for monitoring the temperature and the physical erosion in a high-temperature environment. In some embodiments, the dual-core temperature measurement grid is composed of a plurality of dual-core temperature-sensitive resistors interconnected according to a preset spatial topology structure.

The dual-core temperature-sensitive resistor refers to a sensor device that integrates two electrically isolated and independently calibrated temperature-sensitive resistor cores within a single package. In some embodiments, the dual-core temperature-sensitive resistor includes a sensor core and a reference core. The sensor core uses a platinum-rhodium alloy cable, and a resistance of the sensor core is affected by both the environment temperature and the corrosion degree. The reference core selects a platinum-rhodium alloy cable of the same specification and applies a ceramic insulation coating, and a resistance change of the reference core is only affected by temperature.

In some embodiments, the dual-core temperature measurement grid is formed by embedding a dual-core temperature-sensitive resistor cable in a serpentine layout inside the throat brick. Merely by way of example, the dual-core temperature-sensitive resistor cable is embedded inside the throat brick in the serpentine layout to cover an entire region of the throat brick. A plurality of key points are defined along straight segments of the serpentine layout at a preset distance, and measurement wires are led out from each key point. A cable segment between any two adjacent key points constitutes an independent sensor unit. Both ends of each sensor unit are connected to an external multi-channel micro-ohmmeter via lead wires to obtain a resistance value of each sensor unit, thereby achieving a distributed monitoring of the temperatures and the corrosion states of different regions of the throat brick. The preset distance may be preset manually. For example, the preset distance is 2 cm, 4 cm, etc.

The multi-channel micro-ohmmeter refers to an electronic instrument equipped with a plurality of input channels, which utilizes an internal switch matrix for automatic channel selection, enabling batch measurement of a plurality of independent low-resistance values.

The central control unit refers to a working unit responsible for processing information, executing instructions, and coordinating works of various portions.

In some embodiments, the central control unit obtains data and/or information from the dual-core temperature measurement grid, the first cooling system, the second cooling system, etc. The central control unit may execute program instructions based on the data, the information, and/or processing results to perform one or more functions described in the present disclosure. In some embodiments, the central control unit includes a central processing unit (CPU), an application-specific integrated circuit (ASIC), an application-specific instruction processor (ASIP), etc., or any combination thereof.

The cooling medium refers to an intermediate substance used to absorb and carry heat during a heat transfer process. In some embodiments, the cooling medium is a cooling liquid or a cooling gas, e.g., compressed air, nitrogen, water, oil, or other cooling fluids with good thermal conductivity and stability.

In some embodiments, the cooling medium includes a first coolant and a second coolant. The first coolant and the second coolant are respectively introduced into the first cooling system and the second cooling system.

The cooling medium flow rate refers to a volume or a mass of the cooling medium flowing through a cross-section of a channel of the cooling system per unit time.

In some embodiments, the central control unit is configured to control the cooling medium flow rate of at least one of the first cooling system and the second cooling system. For example, the central control unit controls the cooling medium flow rate of at least one of the first cooling system and the second cooling system by controlling an output frequency of a frequency converter connected to a cooling pump motor of at least one of the first cooling system and the second cooling system.

In some embodiments, at least one of the first cooling system and the second cooling system includes: the cooling pump motor and the frequency converter connected to each other.

The cooling pump motor refers to an electric motor that drives a cooling pump to operate, which is configured to provide power to circulate the cooling medium for heat dissipation.

The frequency converter refers to a device that controls a rotation speed of the electric motor by adjusting a power supply frequency.

In some embodiments, the central control unit is configured to obtain a real-time temperature distribution of the throat brick; determine a cooling medium flow rate through a flow rate determination model based on a target temperature interval of the throat brick, the real-time temperature distribution, and a temperature adjustment duration; and adjust a cooling medium flow rate output by the cooling pump motor by controlling the frequency converter according to the cooling medium flow rate determined through the flow rate determination model.

The real-time temperature distribution refers to a temperature field state jointly indicated by a set of temperature values collected by all sensor units arranged inside the throat brick at the same time and a spatial topology structure thereof. The real-time temperature distribution is expressed as [(x₁, y₁, T₁), (x₂, y₂, T₂), . . . , (xᵢ, yᵢ, Tᵢ)], where (xᵢ, yᵢ) denotes center coordinates of an i-th sensor unit, T₁ denotes a real-time temperature collected by the i-th sensor unit at a time T, and i denotes a count of the arranged sensor units.

In some embodiments, by reading a resistance value of the reference core of each sensor unit through the multi-channel micro-ohmmeter, the central control unit obtains the real-time temperature distribution based on a resistance-temperature curve of the reference core. The resistance-temperature curve may be provided by a manufacturer of the dual-core temperature-sensitive resistance cable.

The target temperature interval refers to a temperature range that the throat brick is expected to reach and maintain. For example, the target temperature interval is 750° C.-800° C.

In some embodiments, the target temperature interval is set by those skilled in the art based on experience.

The temperature adjustment duration refers to a time period required to adjust a current temperature of the throat brick to the target temperature interval. In some embodiments, the temperature adjustment duration is set by those skilled in the art based on experience.

In some embodiments, the central control unit determines the cooling medium flow rate through the flow rate determination model.

The flow rate determination model refers to a model configured to determine the cooling medium flow rate of the second cooling system. In some embodiments, the flow rate determination model is a machine learning model. For example, the flow rate determination model includes one or a combination of a neural network (NN) model, a convolutional neural network (CNN) model, or other custom models.

In some embodiments, an input of the flow rate determination model includes the target temperature interval, the real-time temperature distribution, and the temperature adjustment duration, and an output of the flow rate determination model is the cooling medium flow rate.

In some embodiments, the flow rate determination model is obtained by training an initial flow rate determination model with a plurality of first training samples with first labels. The first training sample may include the target temperature interval, the temperature adjustment duration, and the real-time temperature distribution. The first label may include the cooling medium flow rate under the first training sample.

In some embodiments, the first training sample and the first label are obtained based on experimental data. An experimental process may be: for different initial temperature distributions, setting different cooling medium flow rates through experiments, recording the temperature changes over time; when the temperature enters the target temperature interval, collecting the real-time temperature distribution, a duration for the temperature to reach the target temperature interval (i.e., the temperature adjustment duration), and the corresponding cooling medium flow rate, and using the target temperature interval, the temperature adjustment duration, and the real-time temperature distribution as the first training sample, and using the cooling medium flow rate as the first label.

In some embodiments, a plurality of first training samples with first labels are input into the initial flow rate determination model, a loss function is constructed through the first labels and results of the initial flow rate determination model, and parameters of the initial flow rate determination model are iteratively updated based on the loss function through gradient descent or other manners. When a preset condition is satisfied, the model training is completed, and a trained flow rate determination model is obtained. The preset condition may be that the loss function converges, an iteration count reaches a threshold, etc.

In some embodiments, the central control unit controls the frequency converter connected to the cooling pump motor based on the cooling medium flow rate output by the flow rate determination model, thereby adjusting the cooling medium flow rate output by the cooling pump motor. For example, when a cooling demand increases and the cooling medium flow rate is insufficient, an output frequency of the frequency converter is increased to drive the cooling pump to accelerate and increase the cooling medium flow rate; and when cooling demand decreases and the cooling medium flow rate is redundant, the output frequency is decreased to decrease the cooling medium flow rate.

In some embodiments of the present disclosure, by obtaining an internal temperature distribution in real time and combining the flow rate determination model to dynamically determine the cooling medium flow rate, a precise control of the temperature of the throat brick is achieved, a risk of erosion caused by excessively high temperature is avoided, and a stability of a production process and a safety of device operation are improved.

In some embodiments of the present disclosure, by arranging the dual-core temperature measurement grid in the throat brick, the device is able to accurately perceive an internal temperature distribution state in real time, thereby providing a reliable data support for determining the flow rates of the first cooling system and the second cooling system, and achieving dynamic cooling.

In some embodiments, as shown in FIG. 1, the first cooling system includes a cooling coil or a multi-layer cold air pipe, and the cooling coil or the multi-layer cold air pipe is disposed in the throat brick 2 and forms a flow path on two sides of an outer wall of the conduit structure.

In some embodiments, a cooling manner of the first cooling system is an inner pool wall surface cooling manner.

The cooling coil refers to a coiled structure arranged on a surface of a portion to be cooled, which is used to achieve heat conduction and dissipation through the cooling medium.

The multi-layer cold air pipe refers to a pipeline structure arranged on the portion to be cooled and composed of a plurality of concentric or stacked layers, and is used to introduce the cooling medium to achieve heat conduction and dissipation. For example, the multi-layer cold air pipe is a pipe coiled in the inner wall of the throat, and the cooling medium flows through the pipe to absorb heat.

In some embodiments, a material of the cooling coil or the multi-layer cold air pipe is the same as the material of the metal conduit 1. In some embodiments, the cooling coil or the multi-layer cold air pipe includes a first coolant inlet 5 and a first coolant outlet 6. The first coolant inlet 5 is arranged on a side of the outer wall of the conduit structure and outside the throat brick 2. The first coolant outlet 6 is arranged on another side of the outer wall of the conduit structure and outside the throat brick 2. The first coolant inlet 5 and the first coolant outlet 6 are respectively used for inflow and outflow of the introduced first coolant, thereby forming a circulation of the cooling medium in the cooling coil or in the multi-layer cold air pipe to achieve different cooling effects.

In some embodiments of the present disclosure, the first cooling system reduces the temperature of the glass fluid transmitted to the throat brick through the cooling coil or the multi-layer cold air pipe, effectively reduces the temperature of the throat brick, slows down the rate of erosion by the glass fluid, and extends a structural life.

In some embodiments, as shown in FIG. 2, the second cooling system includes a cooling plate or a cooling pipe embedded inside the throat brick 2, the cooling plate or the cooling pipe serves as a removable component of the throat brick 2 and forms a flow path in the throat brick 2 on the outer wall of the conduit structure.

The cooling plate refers to a plate-shaped cooling structure installed inside the throat brick, through which the cooling medium is introduced to cool the throat brick. For example, the cooling plate is a plate-shaped component with an internal flow channel which is embedded inside the throat brick, and the cooling medium flows through the flow channel.

The cooling pipe refers to a hollow tubular structure installed inside the throat brick, through which the cooling medium is introduced to cool the throat brick. For example, the cooling pipe is a straight pipe or a bent pipe embedded inside the throat brick, and the cooling medium flow rates through the pipe.

The removable component refers to a constituent part that can be completely removed from an installation position without causing a permanent damage to the device or the component itself. In some embodiments, the cooling plate and the cooling pipe are removable components of the throat brick, and a count of cooling plates or cooling pipes is increased or decreased according to heat dissipation requirements.

By designing the cooling plate or the cooling pipe into interconnecting standard modules that serve as detachable components of the throat brick, a modular design is achieved. These modules may be manufactured, replaced, or combined individually to adapt to the temperatures and the erosion conditions in different furnace regions. The modular design improves a flexibility and a maintenance efficiency of the cooling system.

In some embodiments, the cooling plate or the cooling pipe includes a second coolant inlet 8 and a second coolant outlet 9 disposed outside the throat brick 2. The second coolant inlet 8 is disposed on one side of the outer wall of the conduit structure and outside the throat brick 2. The second coolant outlet 9 is disposed on another side of the outer wall of the conduit structure. The second coolant inlet 8 and the second coolant outlet 9 are respectively used for the inflow and outflow of the introduced second coolant, forming a circulation of the cooling medium in the cooling plate or the cooling pipe, thereby improving targeting and effectiveness of cooling.

In some embodiments of the present disclosure, arranging the removable cooling plate and cooling pipe inside the throat brick allows for better adaptation to the temperatures and the erosion conditions at different portions, thereby improving the targeting and the effectiveness of cooling.

In some embodiments, the device for conveying molten glass includes the conduit structure and the first cooling system.

In some embodiments, the device for conveying molten glass includes the conduit structure and the second cooling system.

When a platinum-rhodium alloy is selected as the material for the conduit, a resistance of the conduit to high temperature and erosion is significantly improved. However, in high-temperature environments exceeding 1560° C., the strength of the conduit itself also needs enhancement. Therefore, in some embodiments of the present disclosure, an outer contour of the metal conduit 1 is mechanically optimized, i.e., a bellows structural form is adopted.

The corrugated shape of bellows gives the conduit a higher bending strength and torsional strength. When subjected to external forces, corrugations may disperse stress and reduce local stress concentration, thereby improving the strength of the entire structure. Compared with a traditional straight pipe, the corrugated shape of the bellows increases a surface area of the material, allowing heat to be distributed more uniformly and reducing a risk of local overheating. In high-temperature environments, materials undergo a thermal expansion. The corrugated structure of the bellows may provide a certain degree of thermal expansion compensation, and reduce stress caused by thermal expansion and contraction. Additionally, the flexibility of the corrugations allows the bellows to automatically adjust its shape during temperature changes, thereby reducing an impact of thermal stress on the structure. Therefore, in some embodiments of the present disclosure, the bellows structural form is adopted as the primary design for the support strength of the conduit.

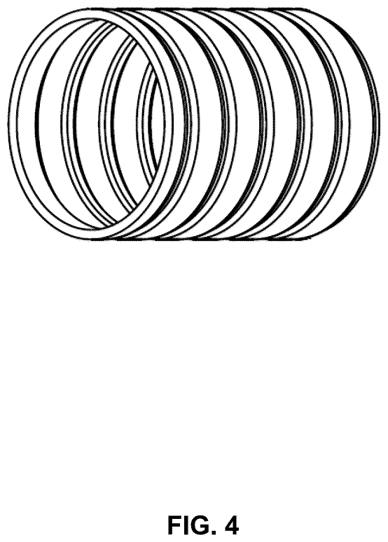

FIG. 4 is a schematic diagram illustrating a bellows structure of a conduit of a device for conveying molten glass according to some embodiments of the present disclosure.

In some embodiments, as shown in FIG. 4, at least one metal conduit has a bellows shape. A structural form of the bellows shape includes at least one of a first bellows structure 10 or a second bellows structure 11.

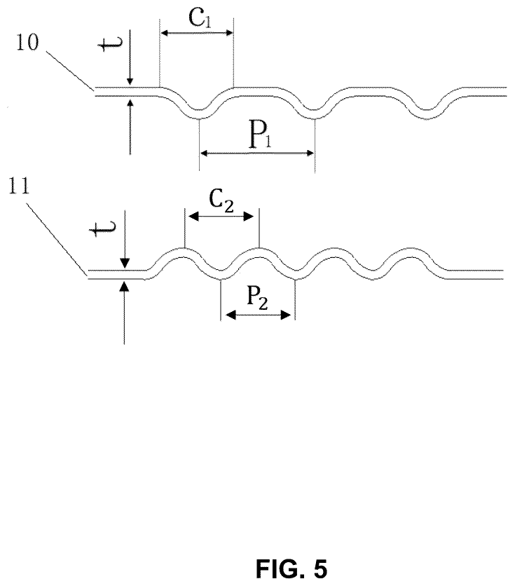

FIG. 5 is a schematic diagram illustrating a bellows form of a conduit of a device for conveying molten glass according to some embodiments of the present disclosure.

In some implementations, at least one metal conduit has a bellows shape. A structural form of the bellows shape includes the first bellows structure 10.

In some embodiments, as shown in FIG. 5, the first bellows structure 10 includes a plurality of first crests and a plurality of first troughs. For each first crest of the plurality of first crests, the first crest includes one crest and one straight pipe. For each first trough of the plurality of first troughs, a width C₁ of the first trough and the outer diameter D of the metal conduit 1 satisfy a relationship: 0.02 D<C₁<0.04 D. A pitch P₁ between two adjacent first troughs and the width C₁ of the first trough satisfy a relationship: 0.5 C₁<P₁<2.0 C₁.

In some embodiments, the at least one metal conduit adopts the first bellows structure. By precisely designing the width C₁ of the first trough to be in a range of (0.02 D-0.04 D) and controlling the pitch P₁ of adjacent troughs within a range of (0.5-2.0) C₁, the first bellows structure achieves an optimized matching of the crests and the troughs. In this way, the stress is effectively dispersed, stress concentration is significantly reduced, thereby improving a bending strength and a torsional strength of the at least one metal conduit.

In some embodiments, the at least one metal conduit has the bellows shape. The structural form of the bellows shape includes the second bellows structure 11.

In some embodiments, as shown in FIG. 5, the second bellows structure 11 includes a plurality of second crests and a plurality of second troughs. For each second crest of the plurality of second crests, the second crest includes one crest. For each second trough of the plurality of second troughs, a width C₂ of the second trough and the outer diameter D of the at least one metal conduit satisfy a relationship: 0.02 D<C₂<0.04 D. A pitch P₂ of two adjacent second troughs and the width C₂ of the second trough satisfy a relationship: P₂=C₂.

In some embodiments of the present disclosure, the at least one metal conduit adopts the second bellows structure. By setting the second trough width C₂ to be in the range of (0.02 D-0.04 D) and adopting an equal-pitch design where the pitch P₂ equals to C₂, a distribution of crests and troughs becomes more balanced. When subjected to a radial pressure, the second bellows structure may be more effectively resist external forces through uniform deformation and exhibit a higher structural strength. On the other hand, the second bellows structure also has an excellent and consistent radial force release performance when the stress needs to be relieved.

In some implementations, the at least one metal conduit has the bellows shape. The structural form of the bellows shape includes the aforementioned first bellows structure 10 and the second bellows structure 11. For example, the at least one metal conduit adopts the first bellows structure 10, or adopts the second bellows structure 11, or simultaneously adopts the first bellows structure 10 and the second bellows structure 11. For example, a first half of the at least one metal conduit adopts the first bellows structure 10, and a second half of the at least one metal conduit adopts the second bellows structure 11.

In some embodiments of the present disclosure, the at least one metal conduit adopts the structural form of the bellows shape, which effectively enhances the bending strength and the torsional strength of the at least one metal conduit. When subjected to the external forces, the corrugations disperse stress and reduce local stress concentration, thereby improving an overall strength.

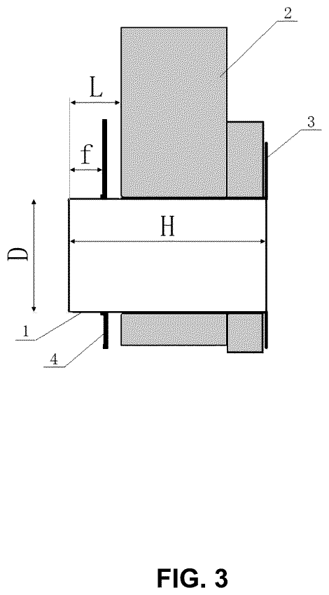

FIG. 3 is a schematic diagram illustrating assembly sizes of a device for conveying molten glass according to some embodiments of the present disclosure.

In some embodiments, based on a simulation analysis of a glass flow state in a conduit region, and to further reduce an erosion effect of the glass fluid 7 on a root of the throat brick 2, as shown in FIG. 3, an axial length H of a conduit structure is greater than an axial length of a throat. A fluid inlet end of the conduit structure protrudes from one end of the throat corresponding to the conduit structure.

The fluid inlet end of the conduit structure refers to an end of the conduit structure where the glass fluid 7 flows in.

In some embodiments of the present disclosure, the axial length H of the conduit structure is greater than the axial length of the throat, and the fluid inlet end of the conduit structure is made to protrude from the throat. This avoids the fluid inlet end of the conduit structure, where the glass fluid 7 flows in, being flush with a surface of the throat brick 2, thereby reducing a direct impact and an erosion effect of the glass fluid on the root of the throat brick.

In some embodiments, a length L of a protruding portion of the conduit structure protruding from the throat, the axial length H of the conduit structure, and the outer diameter D of the at least one metal conduit satisfy a relationship: 0.05 D<L<0.3H.

The length of the protruding portion refers to a length of an end of the conduit structure protruding from the throat relative to an end surface of the throat.

In some embodiments of the present disclosure, by limiting the length L of the conduit structure protruding from the throat to 0.05 D<L<0.3H, the erosion effect of the glass fluid 7 on the root of the throat brick 2 can be further reduced.

FIG. 6 is a schematic diagram illustrating an erosion state of a conduit and a throat brick without a protective structure in the prior art.

As shown in FIG. 6, as a conduit end of the throat brick 2 has no baffle design, the erosion by the glass fluid 7 in this region is very severe. Without a protection of a baffle, the glass fluid 7 may directly impact an inner wall of the throat brick 2, causing continuous erosion reactions on an inner surface of the throat brick 2.

In some embodiments, an erosion mechanism of the glass fluid 7 on the throat brick 2 of the furnace is mainly divided into three forms: chemical reaction erosion, physical erosion by scouring, and thermal stress erosion. If the erosion of the throat brick 2 is not effectively controlled, it may ultimately lead to a reduction in structural strength due to a decreased thickness, and potentially cause a rupture and a collapse of the throat brick 2, thereby affecting the stability and lifespan of the furnace. The erosion also causes the surface of the throat brick 2 to become rough and uneven, which affects a local flow performance of the glass fluid 7, leading to a worsening and an expansion of local vortices in the glass fluid 7, thereby exacerbating the problem further. Additionally, the erosion of the throat brick 2 generates a large amount of waste slag and impurities, and the waste slag and impurities may enter the glass fluid 7, affecting the purity and quality of the glass.

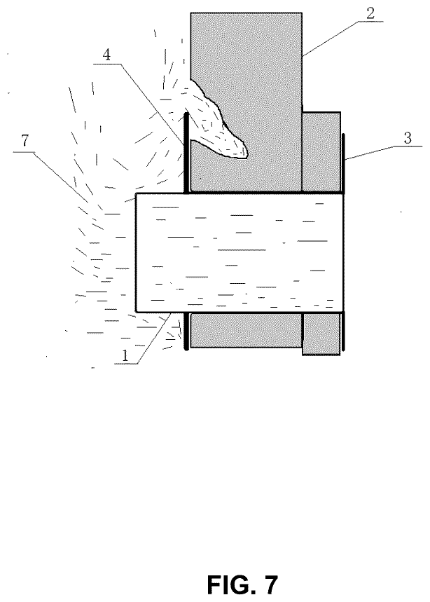

FIG. 7 is a schematic diagram illustrating an erosion state of a throat brick after adding an internal protective plate structure to a device for conveying molten glass according to some embodiments of the present disclosure.

In some embodiments, as shown in FIG. 3 and FIG. 7, a fluid inlet side of a throat is provided with a protective baffle 4. The protective baffle 4 is arranged along an outer peripheral surface of the conduit structure and is fitted to a sidewall of the throat brick 2.

The fluid inlet side of the throat refers to an outer side of an end of the throat close to the glass fluid. The protective baffle 4 refers to a plate-shaped component disposed on the fluid inlet side for protecting a brick body. For example, the protective baffle is an annular or a specially shaped plate installed around the outer peripheral surface of the conduit, and is used to block the glass fluid from directly impacting the throat brick.

In some embodiments, the protective baffle may be installed along the outer peripheral surface of the conduit and is fitted to the sidewall of the throat brick to form a physical barrier blocking direct impact by the glass fluid. A shape and a size of the protective baffle may be selected according to a conduit configuration and fluid dynamics requirements.

In some embodiments, a distance f between the protective baffle 4 and the end surface of the fluid inlet end of the conduit structure and a length L of the protruding portion satisfy a relationship: 0.9 L<f≤L.

In some embodiments, a wall thickness of the protective baffle 4 is negligible compared to the length L, i.e., the wall thickness of the protective baffle 4 is much smaller than the length of the protruding portion.

In some embodiments, the protective baffle 4 and the conduit structure are connected by welding. In some embodiments, the protective baffle 4 and the conduit structure are connected by a mechanical manner including but not limited to screws, pins, hinges, or snap-fit connections.

In some embodiments, a shape of the protective baffle 4 is circular or partially circular, elliptical, or partially elliptical, rectangular, or of other polygonal structures.

In some embodiments, considering that a space between a bottom of the conduit and a bottom of a furnace pool is limited, the protective baffle is a heterotypic structure, e.g., a lower portion is a flat rectangle, and an upper portion is a rounded rectangle or a semicircular design, to protect the surface of the throat brick 2 in the region around the conduit to the greatest extent.

In some embodiments, the protective baffle 4 is disposed along the outer peripheral surface of the conduit structure for molten glass, and is not fitted to a sidewall of the throat brick 2 close to the glass fluid 7, i.e., there is a certain distance between the protective baffle 4 and the sidewall of the throat brick 2 close to the glass fluid 7.

In some embodiments of the present disclosure, the protective baffle 4 is placed as close as possible to an inner pool wall of the throat brick 2, to prevent the glass fluid 7 from directly entering a cooperation gap between the conduit and the throat brick 2 from a rear side of the protective baffle 4, which causes an erosion problem to occur prematurely. The protective baffle 4 forms a physical barrier on the inner pool wall of the throat brick 2 to directly block an impact of the glass fluid 7 on an inner surface of the throat brick 2. During a flow process of the glass fluid 7, the glass fluid 7 first contacts the protective baffle 4, rather than directly impacting the throat brick 2. In this way, a direct scouring force of the glass fluid 7 on the brick body is reduced, thereby slowing down an erosion rate. In addition, the presence of the protective baffle 4 changes a flow path of the glass fluid 7. After encountering the protective baffle 4, a flow direction of the glass fluid 7 changes, causing a portion of the impact force to be dispersed and weakened, which further reduced the erosion effect of the glass fluid on the throat brick 2.

In some embodiments, a dual-core temperature measurement grid is disposed within the protective baffle. More details about the dual-core temperature measurement grid may be found in the relevant descriptions above.

In some embodiments of the present disclosure, installing the dual-core temperature measurement grid on the protective baffle enables real-time monitoring of resistance value changes of dual-core temperature-sensitive resistors on the protective baffle, thereby providing a timely warning for baffle replacement based on an erosion state of the protective baffle, and reducing a risk of the glass liquid seeping into a gap between the conduit and the throat brick due to a severe erosion of the protective baffle.

In some embodiments, the central control unit is further configured to obtain a theoretical resistance value and an actual resistance value of a sensor core in the protective baffle, determine whether a warning needs to be triggered based on the theoretical resistance value and the actual resistance value, and issue a warning prompt in response to determining that the warning needs to be triggered.

The theoretical resistance value refers to a reference resistance value that the sensor core, unaffected by physical erosion, should possess according to its original ideal state. In some embodiments, the central control unit determines a real-time temperature according to the resistance-temperature curve of the reference core, and then obtain a resistance of the sensor core at the real-time temperature according to the real-time temperature and a resistance-temperature curve of the sensor core, as the theoretical resistance value.

The actual resistance value is an actual resistance value obtained by measuring the sensor core using the multi-channel micro-ohmmeter.

In some embodiments, the central control unit determines whether to trigger the warning based on a relationship between a ratio of the actual resistance value to the theoretical resistance value and an erosion threshold. The erosion threshold may be set according to the experience of those skilled in the art.

There are two known situations: one is that the warning needs to be triggered and the other is that the warning does not need to be triggered. In some embodiments, if the ratio of the actual resistance value to the theoretical resistance value is greater than the erosion threshold, it is determined that the warning needs to be triggered. In response to determining that the warning needs to be triggered, the warning prompt is issued.

The erosion threshold may be set based on historical experience, for example, the erosion threshold may be set to 2.

The warning prompt refers to a warning signal issued before a complete failure by monitoring a degree of deviation of the actual resistance value of the sensor core from the theoretical resistance value. For example, the warning signal is “Please replace the baffle”.

In some embodiments of the present disclosure, triggering the erosion warning by comparing the theoretical resistance value and the actual resistance value of the sensor core enables a real-time, quantitative assessment of the health state of the protective baffle. In this way, a previous examination mode that relies on an empirical judgment or a shutdown maintenance is changed. It provides a warning before the baffle fails due to erosion, thereby achieving a predictive maintenance and avoiding production interruptions and safety accidents that are caused by sudden baffle damage.

In some embodiments, an external connection surface 3 is disposed at an end surface of a fluid outlet end of the conduit structure. The external connection surface 3 is configured to be connected to other conduits.

The external connection surface refers to a component that cooperates with an internal connection surface or a matching component of an adjacent conduit to achieve a connection of conduits. For example, the external connection surface is an annular protrusion or a flange structure. A specific size and shape of the external connection surface may be designed according to connection requirements.

In some embodiments, along a radial direction of the at least one metal conduit of the conduit structure, a distance from the external connection surface 3 to the outer peripheral surface of the fluid outlet end of the conduit structure is greater than 25 mm. For example, the distance is 30 mm, 35 mm, 40 mm, etc.

The fluid outlet end of the conduit structure refers to an end of the conduit structure away from the glass fluid 7.

In some embodiments of the present disclosure, by disposing the external connection surface at the end surface of the fluid outlet end of the conduit structure, it is ensured that when a plurality of conduit structures are connected for use, the glass fluid flows smoothly through interiors of the plurality of conduits, avoiding a leakage from connection surfaces.

A method for conveying molten glass is implemented using the aforementioned device for conveying molten glass. The method for conveying molten glass includes the following operations.

First, the first cooling system is disposed on the inner wall of the throat without contacting the conduit structure, and/or the second cooling system is disposed inside the throat brick 2.

Second, the conduit structure is penetrated through the throat in the throat brick 2 to form the transmission channel for the glass fluid 7, and the transmission channel is configured to convey the glass fluid 7.

Finally, the cooling medium is introduced into at least one of the first cooling system or the second cooling system to form a cooling flow path.

In some embodiments, the method for conveying molten glass includes the following operations.

First, the cooling coil or the multi-layer cold air pipe is disposed in the throat brick 2 and a flow path is formed on two sides of the outer wall of the conduit structure, and/or the cooling plate or the cooling pipe is embedded inside the throat brick 2 as the removable component of the throat brick 2, and the flow path is formed in the throat brick 2 on the two sides of the outer wall of the conduit structure.

Second, at least one metal conduit is penetrated through the throat in the throat brick 2 to form the transmission channel for the glass fluid 7, and the transmission channel is configured to convey the glass fluid 7.

Finally, cooling water or cooling air is made to flow in and out through the first cooling medium inlet 5 and the first cooling medium outlet 6, and/or the cooling water or the cooling air is made to flow in and out through the second cooling medium inlet 8 and the second cooling medium outlet 9.

In some embodiments of the present disclosure, the device for conveying molten glass from a furnace in the present disclosure includes: the conduit structure, and at least one of the first cooling system or the second cooling system. The conduit structure penetrates through the throat in the throat brick to form the transmission channel for the glass fluid, for transmitting the glass fluid. The first cooling system is disposed on the inner wall of the throat without directly contacting the conduit structure, which directly reduces the temperature of the glass fluid transmitted to the throat brick, effectively reduces the temperature of the throat brick, and slows down an erosion rate of the throat brick by the glass fluid, and extends a structural lifespan. The second cooling system is disposed inside the throat brick, which enables the throat brick to better adapt to temperatures and erosion conditions at different portions through a segmented design, thereby allowing a flexible modular design, and improving targeting and effectiveness of cooling. The cooling system may directly cool portions in contact with the glass fluid, and further improves the cooling effect, reduces the temperature of the throat brick, reduces erosion, and enhances quality and efficiency of glass production.

In some embodiments, the method for conveying molten glass further includes: obtaining the real-time temperature distribution of the throat brick; determine the cooling medium flow rate through the flow rate determination model based on the target temperature interval of the throat brick, the real-time temperature distribution, and the temperature adjustment duration; and the central control unit adjusting the cooling medium flow rate output by the cooling pump motor by controlling the frequency converter according to the cooling medium flow rate determined through the flow rate determination model. More details on how to adjust the cooling medium flow rate may be found in the relevant content above.

In some embodiments, the method for conveying molten glass further includes: obtaining the theoretical resistance value and the actual resistance value of the sensor core in the protective baffle; determining whether the warning needs to be triggered based on the theoretical resistance value and the actual resistance value; and in response to determining that the warning needs to be triggered, issuing the warning prompt. More details on how to trigger the warning may be found in relevant descriptions above.

The foregoing descriptions are merely preferred embodiments of the present disclosure, and are not intended to limit the present disclosure. The scope of patent protection of the present disclosure is defined by the claims. Any equivalent structural changes made based on the content and drawings of the present disclosure shall similarly be included within the protection scope of the present disclosure.

1. A device for conveying furnace-molten glass to a rear end, comprising: a conduit structure for molten glass, and at least one of a first cooling system or a second cooling system; wherein:
the conduit structure axially penetrates through a throat in a throat brick to form a transmission channel for a glass fluid, the conduit structure including at least one conduit made of platinum or platinum alloy, wherein the at least one conduit made of platinum or platinum alloy has a bellows shape, and a structural form of the bellows shape includes at least one of a first bellows structure or a second bellows structure;
the first cooling system is disposed on an inner wall of the throat and is not in direct contact with the conduit structure; and
the second cooling system is arranged inside the throat brick.

2. The device of claim 1, wherein the throat brick includes a dual-core temperature measurement grid and a central control unit; wherein the central control unit is configured to control a cooling medium flow rate of at least one of the first cooling system or the second cooling system.

3. The device of claim 2, wherein the at least one of the first cooling system or the second cooling system includes: a cooling pump motor and a frequency converter connected to each other; and
the central control unit is further configured to:
obtain a real-time temperature distribution of the throat brick;
determine a cooling medium flow rate through a flow rate determination model based on a target temperature interval of the throat brick, the real-time temperature distribution, and a temperature adjustment duration; wherein the flow rate determination model is a machine learning model; and
adjust a cooling medium flow rate output by the cooling pump motor by controlling the frequency converter according to the cooling medium flow rate determined through the flow rate determination model.

4. The device of claim 1, wherein the first cooling system includes a cooling coil or a multi-layer cold air pipe, the cooling coil or the multi-layer cold air pipe is disposed in the throat brick and forms a flow path on two sides of an outer wall of the conduit structure.

5. The device of claim 1, wherein the second cooling system includes a cooling plate or a cooling pipe, the cooling plate or the cooling pipe is embedded inside the throat brick as a removeable component of the throat brick, and forms a flow path in the throat brick on two sides of an outer wall of the conduit structure.

6. (canceled)

7. The device of claim 1, wherein the first bellows structure includes a plurality of first crests and a plurality of first troughs;
for each first crest of the plurality of first crests, the first crest includes one crest and one straight pipe; and
for each first trough of the plurality of first troughs, a width C₁ of the first trough and an outer diameter D of the at least one conduit made of platinum or platinum alloy satisfy a relationship: 0.02 D<C₁<0.04 D; and a pitch P₁ between two adjacent first troughs and the width C₁ of the first trough satisfy a relationship: 0.5 C₁<P₁<2.0 C₁.

8. The device of claim 1, wherein the second bellows structure includes a plurality of second crests and a plurality of second troughs;
for each second crest of the plurality of second crests, the second crest includes one crest; and
for each second trough of the plurality of second troughs, a width C₂ of the second trough and an outer diameter D of the at least one conduit made of platinum or platinum alloy satisfy a relationship: 0.02 D<C₂<0.04 D; and a pitch P₂ between two adjacent second troughs and the width C₂ of the second trough satisfy a relationship: P₂=C₂.

9. The device of claim 1, wherein an axial length H of the conduit structure is greater than an axial length of the throat, and a fluid inlet end of the conduit structure protrudes from one end of the throat corresponding to the conduit structure.

10. The device of claim 9, wherein a length L of a protruding portion of the conduit structure protruding from the throat, the axial length H of the conduit structure, and an outer diameter D of the at least one conduit made of platinum or platinum alloy satisfy a relationship: 0.05 D<L<0.3 H.

11. The device of claim 10, wherein a fluid inlet side of the throat is provided with a protective baffle disposed along an outer peripheral surface of the conduit structure and is fitted to a sidewall of the throat brick.

12. The device of claim 11, wherein a distance f between the protective baffle and an end surface of the fluid inlet end of the conduit structure and the length L of the protruding portion satisfy a relationship: 0.9 L<f≤L.

13. The device of claim 11, wherein a dual-core temperature measurement grid is disposed within the protective baffle.

14. The device of claim 11, further comprising a central control unit configured to:
obtain a theoretical resistance value and an actual resistance value of a sensor core in the protective baffle;
determine whether a warning needs to be triggered based on the theoretical resistance value and the actual resistance value; and
in response to determining that the warning needs to be triggered, issue a warning prompt.

15. The device of claim 9, wherein an end surface of a fluid outlet end of the conduit structure is provided with an external connection surface, and the external connection surface is configured to be connected to other conduits.

16. The device of claim 15, wherein in a radial direction of the at least one conduit made of platinum or platinum alloy, a distance between the external connection surface to an outer peripheral surface of the fluid outlet end of the conduit structure is greater than 25 mm.

17. (canceled)

18. A method for conveying furnace-molten glass to a rear end implemented using the device for conveying furnace-molten glass to a rear end of claim 1, wherein the method comprises:
disposing the first cooling system on the inner wall of the throat without contacting the conduit structure, and/or disposing the second cooling system inside the throat brick;
axially penetrating the conduit structure through the throat in the throat brick to form the transmission channel for the glass fluid, the transmission channel configured to convey the glass fluid; and
introducing a cooling medium into at least one of the first cooling system or the second cooling system to form a cooling flow path.

19. The method of claim 18, further comprising:
obtaining a real-time temperature distribution of the throat brick;
determining a cooling medium flow rate through a flow rate determination model based on a target temperature interval, the real-time temperature distribution, and a temperature adjustment duration; wherein the flow rate determination model is a machine learning model; and
adjusting a cooling medium flow rate output by a cooling pump motor by controlling a frequency converter based on the cooling medium flow rate determined through the flow rate determination model.

20. The method of claim 18, further comprising:
obtaining a theoretical resistance value and an actual resistance value of a sensor core in a protective baffle;
determining whether a warning needs to be triggered based on the theoretical resistance value and the actual resistance value; and
in response to determining that the warning needs to be triggered, issuing a warning prompt.
